(19) United States
(12) Patent Application Publication
(10) Pub. No.: US 2007/0216114 A1
(43) Pub. Date: Sep. 20, 2007

(54) Snow Machine Ski

(76) Inventors: Verlin M. Simmons, Providence, UT (US); Val J. Simmons, Providence, UT (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/687,416

(22) Filed: Mar. 16, 2007

Related U.S. Application Data
(60) Provisional application No. 60/846,983, filed on Sep. 25, 2006.
(60) Provisional application No. 60/783,458, filed on Mar. 17, 2006.

(51) Int. Cl. B62B 19/00

(52) U.S. Cl. 280/28

(57) ABSTRACT

A ski for a snowmobile or other snow machine is provided with a pair of lateral wings and a central channel for increasing the flow of snow under a gliding surface at the bottom of the ski. The increased flow of snow enhances flotation of the ski. The channel may be formed by two downwardly extending keels. The wings are defined between the keels and outer edges of the ski.

### RELATED APPLICATIONS

This application claims priority from U.S. Provisional Application Nos. 60/783,458 filed on Mar. 17, 2005, and 60/846,983 filed on Sep. 25, 2006, each application being hereby incorporated by reference in its entirety.

### FIELD OF THE INVENTION

The present invention relates to snow skis. More particularly, the invention relates to snowmobile skis providing for increased deep powder flotation and enhanced steering response and machine maneuverability.

### BACKGROUND OF THE INVENTION

As snowmobiles have improved, it is recognized that the ability of the skis to provide flotation, properly control the snowmobile, and maintain an intended direction of travel have lagged behind. Conventional skis also exhibit shortcomings in the area of flotation in deep powder snow. Typically, in such snow conditions, a high rate of speed can keep the snowmobile ski planing upon the surface. However, on steep slopes or particularly deep snow the ability of the ski to continue planing can be limited

Thus, as technological barriers are being overcome, certain limitations of current snow machines have come glaringly to light. To fully utilize current technological benefits, snowmobiles must be provided with increased flotation ability, steering ability, and tracking capability. Until these needs are met, much terrain will remain impassible or at least dangerous to the operators of snow machines.

### BRIEF SUMMARY OF THE INVENTION

The present invention is directed to a snow ski capable of providing enhanced machine operation across a variety of snow surfaces. In one example, a snowmobile ski embodies aspects of the present invention and is provided with a pair of lateral wings and a central channel for increasing the flow of snow under the ski during operation. The increased flow of snow enhances flotation of the ski, particularly in deep powder conditions. The channel may be formed between two keels, one disposed to either side of a gliding surface of the ski. The pair of lateral wings may be combined as an integrated ski or be separable, replaceable components which may be selectively attached to an existing ski. These wings significantly improve the handling characteristics and capability of the snow machine, particularly in deep snow.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1-4 are a perspective views illustrating an embodiment of the present invention in which a ski is provided with a contoured gliding surface including a channel and a pair of longitudinal powder wings.

FIGS. 5-6 are side elevation views of the ski of FIG. 1.

FIGS. 7-8 are top plan views of the ski of FIG. 1.

FIG. 9 is a front elevation view of the SKI of FIG. 1.

FIG. 10 is a back elevation view of the SKI of FIG. 1.

FIG. 11 is a bottom plan view of the SKI of FIG. 1.

FIG. 12 is a top plan view of the SKI of FIG. 1.

FIG. 13 is a cross-sectional detail of the ski of FIG. 12 taken around line A-A of FIG. 12.

FIG. 14 is a cross-sectional detail of the ski of FIG. 12 taken around line B-B of FIG. 12.

FIG. 15 is a cross-sectional detail of the ski of FIG. 12 taken around line C-C of FIG. 12.

FIG. 16 is a cross-sectional detail of the ski of FIG. 12 taken around line D-D of FIG. 12.

FIG. 17 is a top plan view of the SKI of FIG. 1.

FIG. 18 is a cross-sectional detail of the ski of FIG. 17 taken around line E-E of FIG. 17.

### DETAILED DESCRIPTION OF THE INVENTION

The present invention may be embodied as a snowmobile ski to improve the ski's ability to float on top of deep powder snow, track straight across a variety of terrain, maneuver effectively on steep hills, and turn sharply in different snow conditions, particularly light and deep snow. Other aspects of a snow machine ski are disclosed in Applicant's U.S. Pat. Nos. 5,360,220, 5,836,954 and 6,276,699, each of which are hereby incorporated by reference into this document.

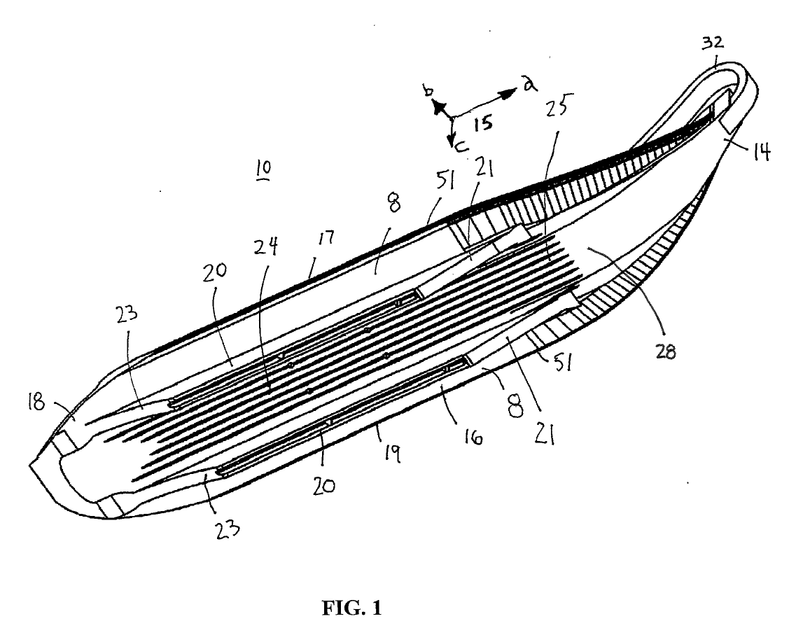

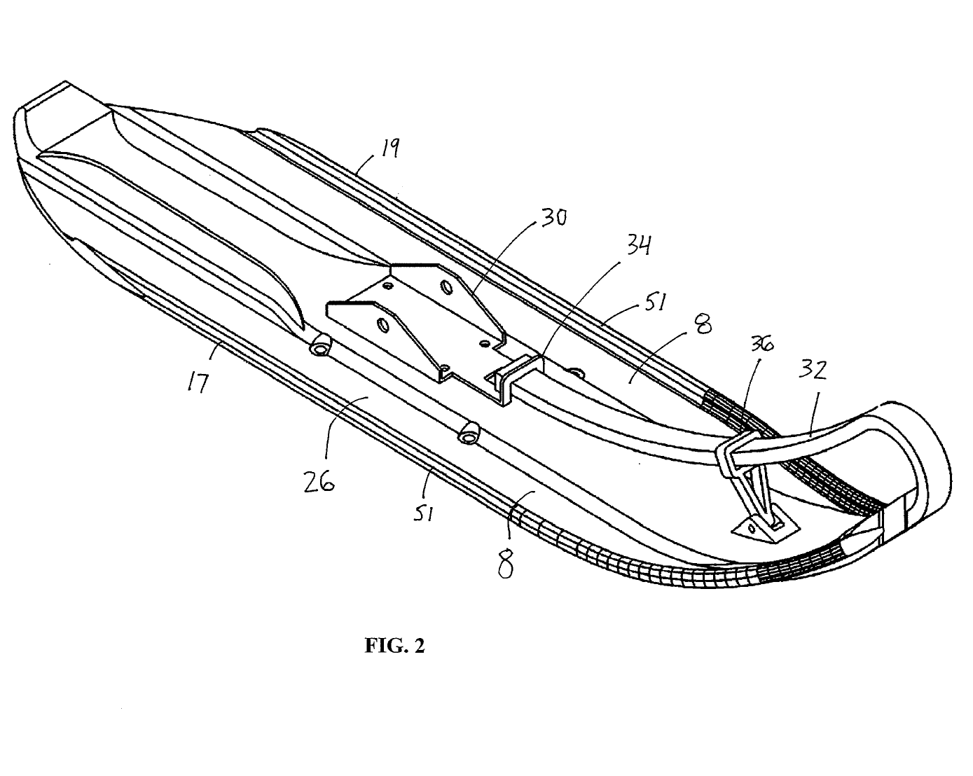

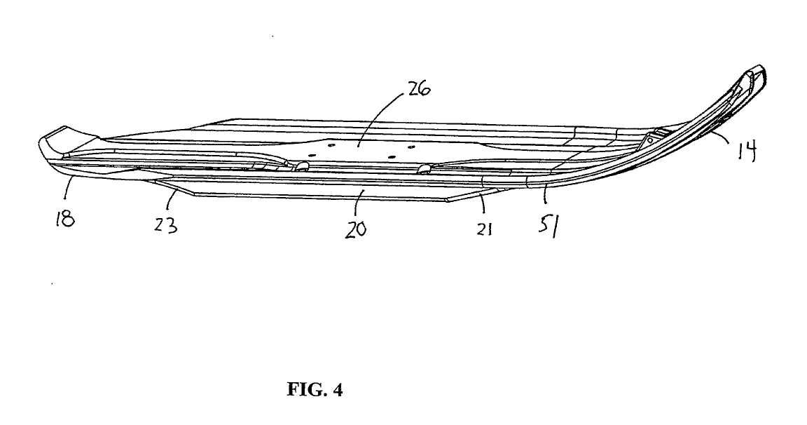

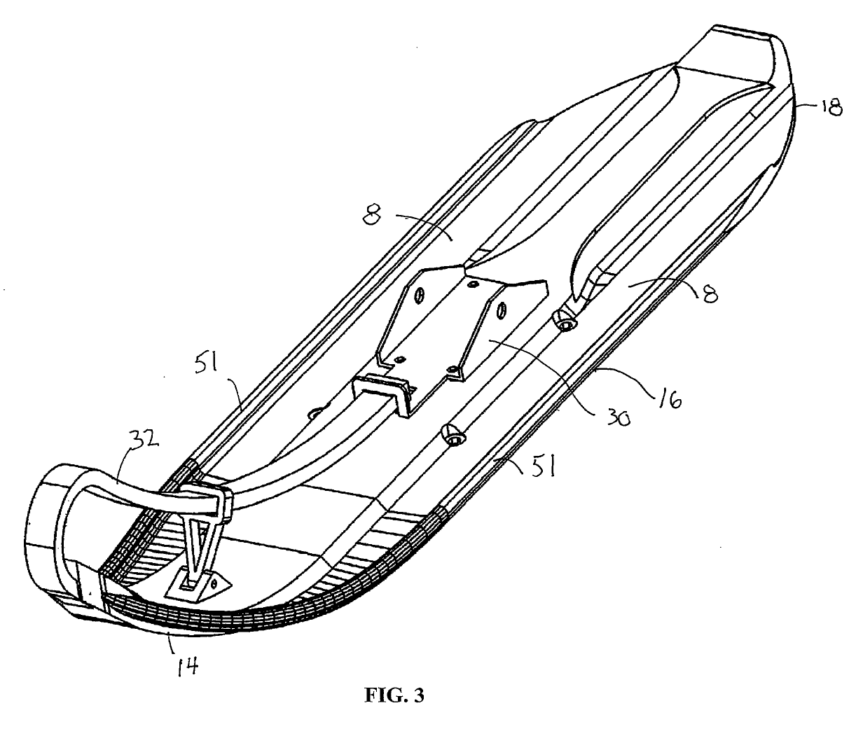

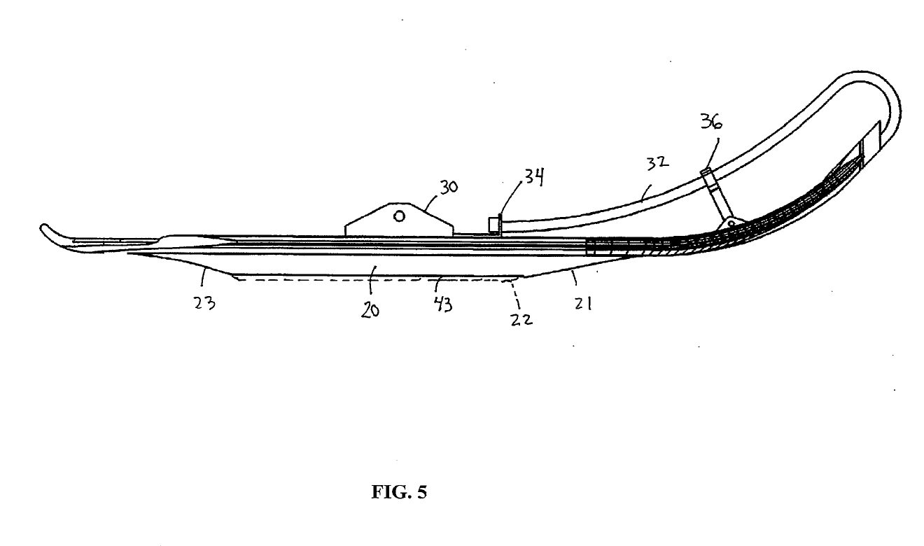

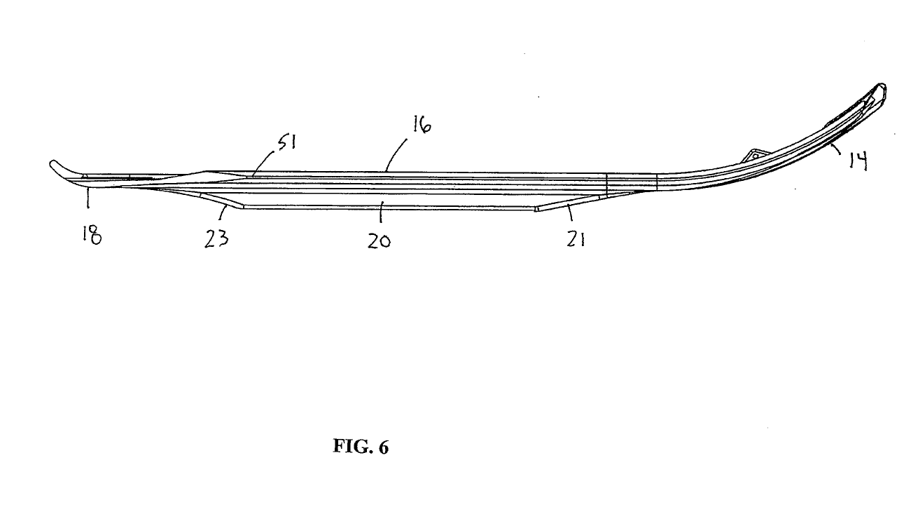

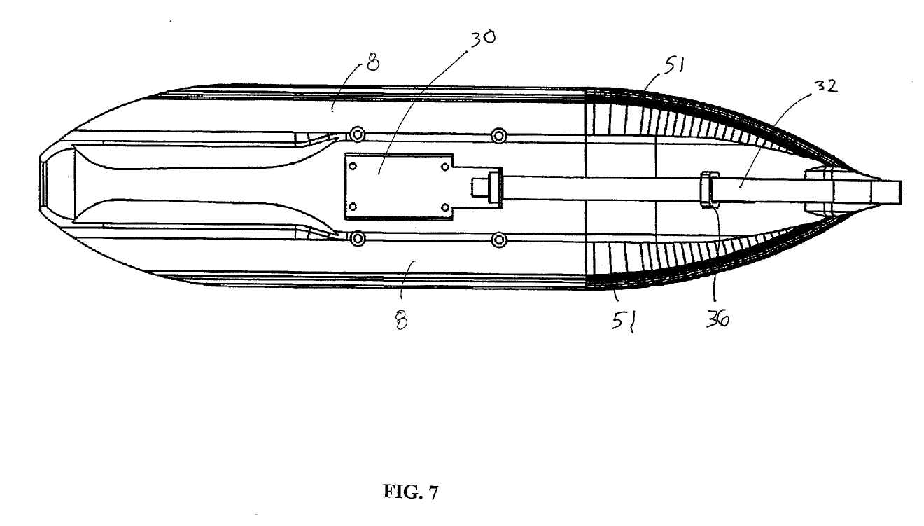

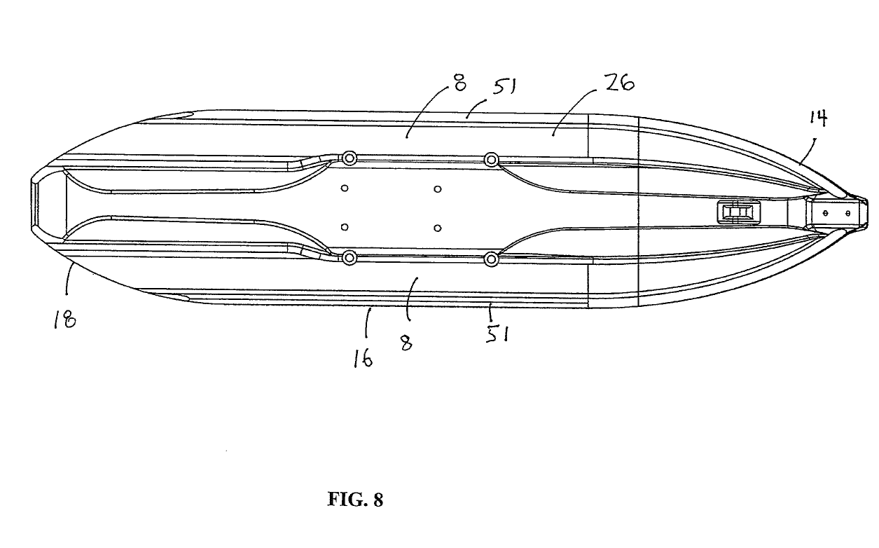

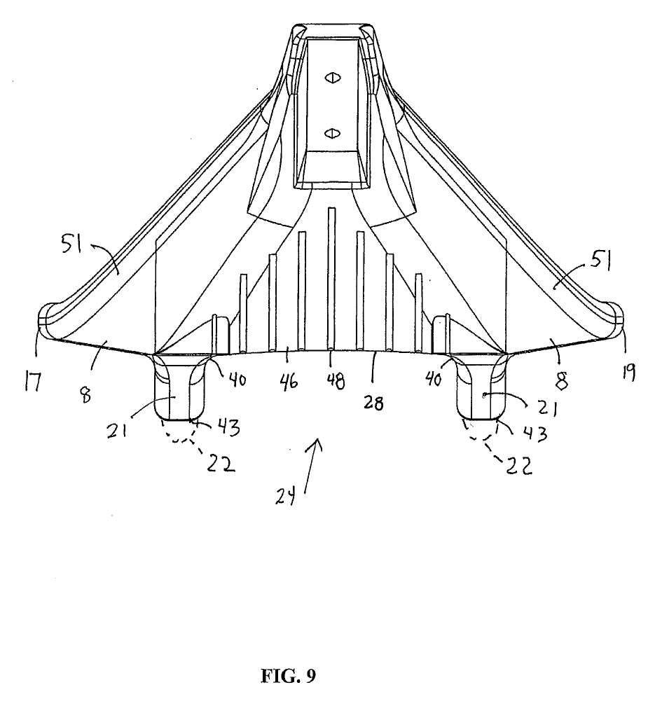

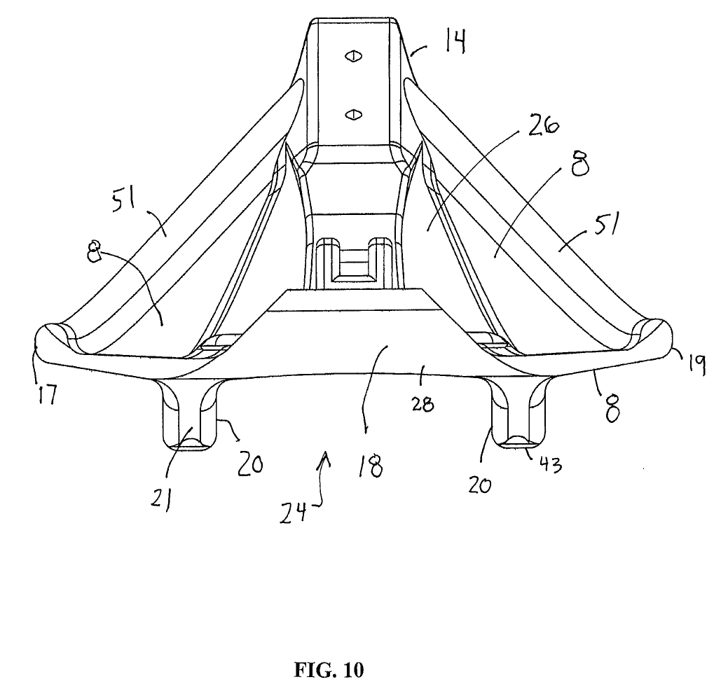

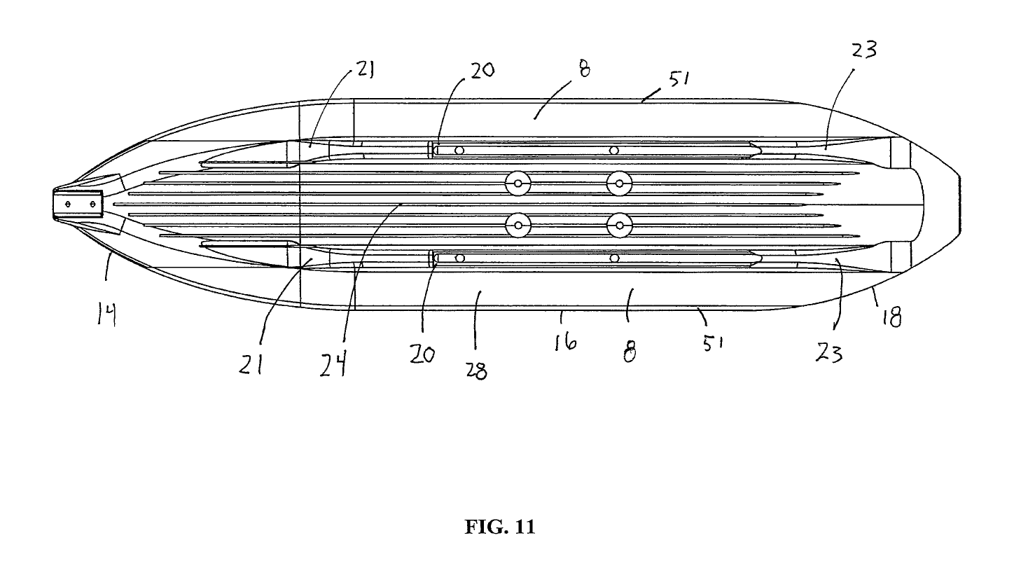

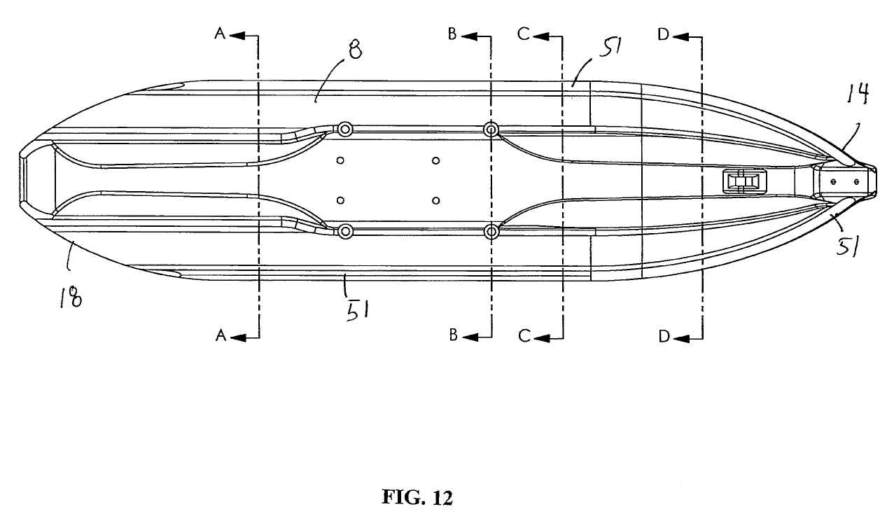

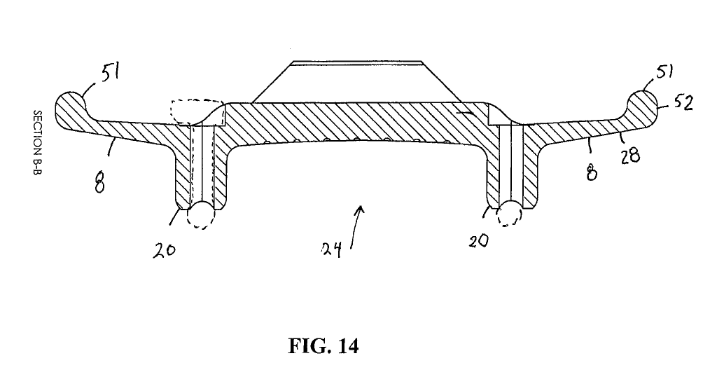

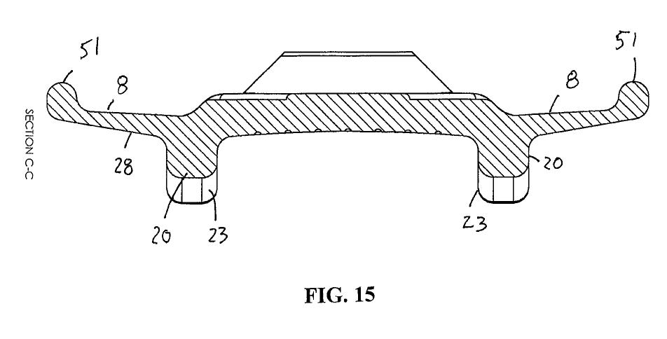

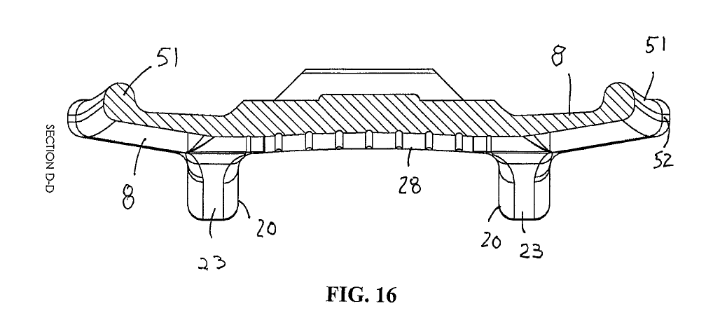

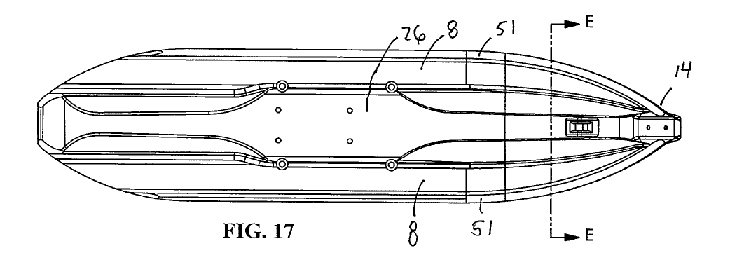

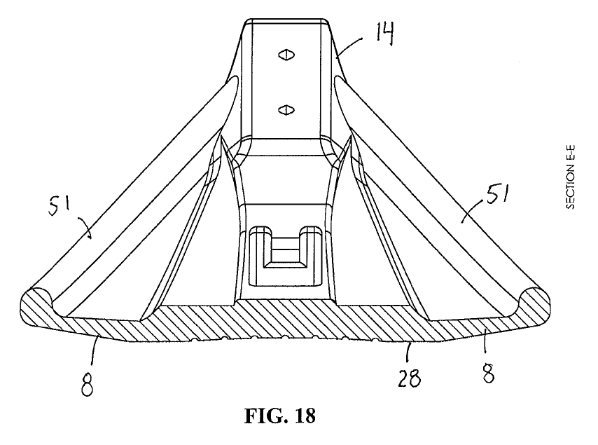

FIGS. 1 through 18 show aspects of snow machine ski 10 in accordance with the present invention. As illustrated in FIG. 1, snow machine ski 10 has a body 12 functionally divided into an upturned tip 14, a tail 18, and an intervening base portion 16. Body 12 of snow machine ski 10 extends in a longitudinal direction 15a from tip 14 through tail 18 and has a width extending in a lateral direction 15b between a first edge 17 and a second edge 19. Body 12 also has a depth in a vertical direction 15c. Ski 10 in FIG. 1 further includes a pair of longitudinally extending wing sections, or “wings” 8. In the illustrated embodiment, ski 10 is generally symmetric about longitudinal plane. For example, keels 20 are equidistant from a centerline of channel 24. In alternative embodiments, keels 20 may be located at different distances relative to edges 17, 19. A gliding surface 28 is generally defined as the ski surface in contact with snow during machine operation, e.g., portions of tip 14, tail 18, base portion 16, wings 18 and keels 20.

The relatively thick base portion 16 provides stiffness to the ski that aids in maintaining flotation and steering ability, while the comparatively thinner tip 14 and tail 18 impart flexibility to ski 10. Flexibility allows tip 14 to bend, aiding the ski to “climb” out of and remain on the surface of deep snow. The flexibility of tip 14 and tail 18 also affords a shock absorption capability to ski 10.

In the illustrated embodiments, wings 8 are substantially thinner than other portions of the body 12. As illustrated, wings 8 are integrated into a single piece molded part. In other embodiments of the invention, wings 8 may be separable parts capable of being removed or replaced after wear or damage. Wings 8 are shown with an upwardly extending, generally planar underside which provides for better ski floatation in deep powder as compared to a ski without wings 8. In other embodiments of ski 10, wings 8 extend generally horizontally (no upward extension). Wings 8 may extend along portions of each edge of the ski and merge into tip 14 and tail 18.

Wings 8 of snow machine ski 10 are preferably homogeneously molded from a material with a relatively low coefficient of friction on snow and ice. A material with a low modulus of elasticity relative to that of metal is also desired. In one embodiment the material is a polymer or plastic. In one preferred embodiment, body 12 is compression molded from a durable thermoplastic material such as TIVAR-brand UHMW. Forming snow machine ski 10 from plastic also reduces the weight and increases the flexibility of the snow machine ski 10.

Wings 8 may preferably be between 1.0 to 6 inches in width (as measured from an edge of keel 20 to ski edge 50). In preferred embodiments of the invention, wings 8 have a width which is approximately 50% of the width of channel 24. In one ski embodiment wings 8 are approximately 3 inches in width. Embodiments of ski 10 of the present invention are preferably between 8 to 14 inches in width, and more particularly between approximately 10-12 inches in width. In a preferred embodiment, ski 8 has a width of approximately 10 inches.

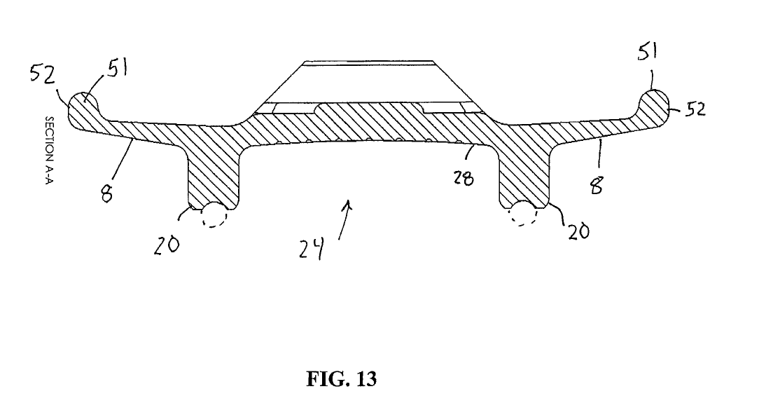

Wing 8 thickness may range from about 0.05 inch to about 0.75 inch. Wing 8 thickness may vary as a function of lateral position from keel 20. As shown in FIGS. 13-16, local wing 8 thickness decreases with an increase in the distance to keel 20, thereby defining a generally tapering form across laterally extending portions of wing 8. In one embodiment of ski 10, a portion of wing 8 has a thickness of approximately ⅛th inch. In a preferred embodiment, wings 8 are substantially thinner than other portions of ski 10 and, as a result, are generally more flexible than other portions of ski 8. During cornering of the snow machine, wings 8 may deflect to provide keels 20 with enhanced access to snow.

In the illustrated embodiment, wings 8 are provided with longitudinal ribs 51. In one embodiment, rib 51 approximates a 0.5 in. solid rod extending along an outer edge of wing 8. In other embodiments, rib 51 can be defined with non-circular cross sections, for example, rectangular or oval shapes. Rib 51, in the illustrated embodiment, is positioned away from the underside of wing 8 surface. In other words, portions of rib 51 would not typically engage snow during straight travel use. In cornering conditions, portions of rib 51 engage snow and tend to prevent the wing 8 edge from burying itself in the snow surface. A portion 52 of rib 51 may be generally vertical and function to provide additional resistance to side slippage in a turn and provide additional structural rigidity to wing 8. In order to improve ski 10 handling characteristics, at least a portion of rib 51 is substantially thicker than portions of wing 8.

A top surface 26 of snow machine ski 10 has provided thereon a means for connecting to the steering mechanism of a snow machine. In the depicted embodiment, a mounting bracket 30 is provided for connecting to a steering spindle of a snowmobile. A loop 32 may be provided to act as a bumper for protecting the front of the ski from impacts, while also providing a gripping handle for the operator. Loop 32 is preferably dynamically mounted at one or both ends, providing flexibility and shock absorption to tip 14.

In the depicted embodiment, loop 32 is fixedly attached to tip 14 of ski 10 with bolts 13. Loop 32 bends up and back, transitioning through a first apertured sliding brace 36, and through a second apertured sliding brace 34. A free end of loop 32 (not shown) is movable in a longitudinal direction with respect to braces 34, 36, allowing it to flex within braces 34, 36. This arrangement allows the tip 14 to flex backwards and absorb shock normally transmitted through conventional snow machine skis.

A concavity 25 is shown formed in the gliding surface of ski 10 beginning at tip 14. In depicted embodiments, two elongated keels 20 protrude downward from edges 17, 19 of base portion 16. While keels 20 may extend over the length of body 12, each of the keels 20 preferably extends longitudinally along the bottom of the base portion 16, and is not present on tip 14 or tail 18. The keels 20 are shown in cross-sectional views in FIGS. 13-16. The gliding surface 28 could be otherwise configured, but is preferably contoured in some manner.

Shown connected to bottom 43 of each of keel 20 is elongated metal wear bar 22. Wear bars 43 are designed to make primary contact with harder surfaces, such as roadways and packed or icy snow, to prevent wear. Wear bars 43 are also designed to focus the weight of the snow machine on a smaller surface area, acting as runners and guides for improved steering control.

Channel 24 is shown defined by portions of the gliding surface, e.g., concavity 25 and inner walls of keels 20. Channel 24 extends in the longitudinal direction 15a along the gliding surface 28 of ski 10, toward tail 18, where ski 10 is depicted as being substantially flat. Consequently, channel 24 is shallow at the tip 14, and increases in depth 13a as it transitions to base portion 16.

In the illustrated embodiment, channel 24 maintains a substantially consistent depth and thickness across a portion of base 16. The keels are preferably about one inch in depth and of a thickness of approximately one half inch In the depicted embodiment the forward tip of each of the keels 20 wedges outward laterally, narrowing in a lateral direction 15b, as keel 20 progresses longitudinally from a forward apex 21 rearward. Keels 20 may each also wedge inward at the rear toward a rear apex 23.

The wedging action of keels 20, together with concavity 25 helps to gather and funnel snow into the front of channel 24, providing lift to the snow machine during operation. The wedging at the rear of keels 20 allows the snow to freely exit from the rear of the channel 24.

In the depicted embodiment, keels 20 are shown wedging downwards from the forward apex 21 rearward. Keels 20 wedge upward again as the keels progress toward rear apex 23. This vertical wedging helps to provide less friction, allow the ski 10 to overcome obstacles, and further increasing flotation of the ski 10.

When ski 10 is moving relative to the snow, a high volume of snow is funneled under ski 10 by concavity 25 and/or keel wedges and captured within channel 24 or engaged by wings 8 to provide additional lift. Snow flowing into channel 24 also provides lift to tip 14, providing additional flotation to the ski 10. Thus, ski 10 provides a resistance to snow in the vertical direction 15c, while providing a minimum of resistance to the flow of snow in the longitudinal direction 15a. The upturned tip 14 of ski 10 provides a transitional contact surface to snow when the ski is sunken within the snow to provide a maximum resistance, causing the ski to climb up out of the snow, and also directing the flow of snow through channel 24.

In order to provide a high surface area for higher vertical resistance and increased planing, snow machine ski 10 may be wider than conventional skis. In a preferred embodiment, body 12 is about 10 inches in width. The top surface 26 of the snow machine ski 10 may be flat, which keeps ski 10 light and renders relatively thin tip 14 and tail 18 more flexible. In other embodiments, top surface 26 may be ribbed or otherwise configured to reduce weight. The base portion 16 preferably does not substantially flex, and is relatively deep to provide strength and reinforcement. The keels 20 also lend structural rigidity to base portion 16. In order to further keep weight to a minimum, while imparting strength, body 12 is shown being of a substantially constant width between keels 20.

To accommodate these considerations while sacrificing only a minimal increase in resistance to the flow of snow, the top of channel 24, as depicted in FIGS. 13-15, may be substantially flat across the center 38 and radiused at corners 40. Thus, the channel 24 may approximate the shape of a half cylinder, for instance, further increasing hydraulic diameter and decreasing resistance to the longitudinal passage of snow past the snow machine ski 10.

To overcome some of the problems of pushing and darting, a series of longitudinal grooves 44 are formed in the gliding surface. Grooves 44 increase the lateral surface area for gripping the snow when snow machine ski 10 is turned relative to the facing of the snow machine. Nevertheless, the unobtrusive narrow width and shallow nature of the grooves 44 allow the gliding surface to be relatively smooth, allowing for low longitudinal friction.

A series of lands 46 are formed between grooves 44. The lands 46 are preferably much wider than grooves 44, forming the majority of the gliding surface. It is preferred that the lands 44 provide a flat contact surface at the tip thereof. In this manner, the gliding surface has a continuous contour, broken only by grooves 44.

The grooved/ribbed gliding surface of ski 10 also increases the shear force available to hold the snow machine ski 10 in the desired lateral position. Moreover, keels 20 tend to capture and pack into the grooves the snow in turns using the skis 10 momentum. Of course, it will be apparent to one skilled in the art that grooves 44 may be configured in other, selected dimensions, cross-sectional shapes, and configurations to balance competing consideration discussed herein. For instance, deepening grooves 44 tends to increase the responsiveness of snow machine skis 10 to a change in course, as does increasing the width and number of the grooves 44 and steepening the sides of grooves 44. Nevertheless, increasing the responsiveness of snow machine skis 10 in this manner can be dangerous to an inexperienced operator or one who is not informed of the increased handling capability of ski 10.

In operation of the snow machine, especially at high speeds in deep powder snow, the skis may function effectively upon principles of fluid dynamics, providing floatation (e.g., by tips 14, channels 24, and wings 8) and ruddering (e.g., by keels 20) in deep or loose snow. Skis 10 may also effectively function upon principles of mechanical dynamics and solid mechanics of snow when snow machine skis 10 are turned, slowed, etc., in wet or packed conditions, thus trapping and packing the snow within channel 24 while allowing wings 8 to easily deflect upwardly and providing addition operative access to keels 20, and causing the snow machine to turn sharply, responsive to a direction set by the operator.

The embodiment of ski 10 having wings 8 and ruddering keels 20, in accord with the present invention, can be used with snow machine skis other than those described in detail herein. Ski 10 of the present invention can also be used on all types of powered snow machines, including dual tracked “snow cat” snow machines and singe ski powered snow machines. As discussed, ski 10 provides snow machines so equipped with better tracking, control, and flotation over a broader range of speeds, snow conditions, and operating conditions over prior art snow machine skis. Furthermore, due to the reduction in pushing and darting, the snow machine ski of the present invention also provides a better ability to traverse hills, allowing an operator to maneuver effectively on hills in any direction without being limited to going only straight up and straight down. This better control, tracking, “side hilling” and flotation allows access to locations that were previously inaccessible to vehicles in winter.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A snow ski comprising:
a base having a top adapted to be connected to a snow machine and a gliding surface disposed at the bottom thereof for traveling over snow, the gliding surface extending in a longitudinal direction positionable to correspond to a desired direction of travel and extending in a lateral direction between a first edge and a second edge;
a pair of keels integral to and extending downwardly from the base, said keels and a portion of said base therebetween defining a snow channel; and
a pair of wings, one extending laterally from said first edge to one of said pair of keels, and the other extending laterally from the second edge to the other of said pair of keels, with a thickness of said pair of wings being substantially smaller than a thickness of the ski within the snow channel.

2. The ski of claim 1 wherein the pair of wings are upwardly tilted away from the lowermost edge of the pair of keels.

3. The ski of claim 2 wherein the pair of wings have tapering cross sections, with end portions of the pair of wings being thinner than other portions of the pair of wings.

4. The ski of claim 1 wherein each one of the pair of wings has a width of approximately 50% of a width of the snow channel.

5. The ski of claim 1 further comprising:
a pair of ribs, each rib being provided along at least a portion of the pair of wings.

6. The ski of claim 5 wherein the pair of ribs extend in an upward direction away from the lowermost edge of the pair of keels.

7. The ski of claim 5 wherein the pair of ribs are defined with generally circular cross sections.

8. The ski of claim 5 wherein the pair of ribs are provided at outer edges of the pair of wings.

9. A snow ski comprising:
a base having a top adapted to be connected to a snow machine and a gliding surface disposed at the bottom thereof for traveling over snow, the gliding surface extending in a longitudinal direction positionable to correspond to a desired direction of travel and extending in a lateral direction between a first edge and a second edge;
a pair of keels extending downwardly from the base away from the first edge and second edge, said pair of keels defining portions of a snow channel, with a concave portion of the base directing snow into the snow channel;
a pair of wings extending alongside the pair of keels; and
a pair of ribs extending along the pair of wings away from the pair of keels, said ribs having a thickness which is substantially greater than a thickness of the pair of wings.

10. The ski of claim 9 wherein a combined width of the pair of wings is approximately equal to a ski width between the pair of keels.

11. The ski of claim 9 wherein the pair of wings have a thickness which is substantially smaller than a thickness of the ski between the pair of keels.

12. The ski of claim 11 wherein the pair of wings have generally tapered cross sections which narrow with an increase in distance from the pair of keels.

13. A snow ski comprising:
a gliding surface disposed at a ski bottom and extending in a longitudinal direction positionable to correspond to a desired direction of travel and extending in a lateral direction between a first edge and a second edge;
a pair of keels defined within the gliding surface, said pair of keels extending downwardly and positioned away from the first edge and second edge, said pair of keels defining portions of a snow channel, with a portion of the ski directing snow into the snow channel; and
a pair of wings extending alongside the pair of keels, said wings being substantially thinner and more flexible than a portion of the ski between the pair of keels.

14. The ski of claim 13 further comprising:
a pair of ribs extending along the pair of wings and away from the pair of keels, said ribs having a thickness which is substantially greater than a thickness of the pair of wings.

15. The ski of claim 14 wherein the ribs have a generally circular cross section.

16. The ski of claim 14 wherein the pair of ribs are longer than the pair of keels as measured in the longitudinal direction.

17. The ski of claim 13 wherein the pair of wings have a tapering cross section.

18. The ski of claim 17 wherein the pair of wings extended upwardly away from the lowermost portion of the pair of keels.

19. The ski of claim 13 wherein a width of one of the pair of wings is approximately 50% of a width of the ski between the pair of keels, as measured in the lateral direction.

20. The ski of claim 19 wherein the widths of each of the pair of keels are approximately equal.

21. The ski of claim 13 wherein each of the pair of keels includes a pair of generally parallel, downwardly extending surfaces and a wear bar provided at a lower portion of each keel.

22. The ski of claim 13 wherein the snow channel has a generally concave cross section.

23. The ski of claim 14 wherein the ribs extend in a continuous manner alongside a portion of the pair of keels.

24. A snow ski comprising:
a gliding surface disposed at a bottom of the ski;
a pair of keels defined within the gliding surface, said pair of keels extending downwardly and positioned away from outer edges of the ski, said pair of keels defining portions of a snow channel, with another portion of the ski directing snow into the snow channel; and
a pair of wings extending alongside the pair of keels, said wings being substantially thinner and more flexible than a portion of the ski between the pair of keels.

25. The ski of claim 24 wherein said another portion includes a concave structure tending to funnel snow into the snow channel.

26. The ski of claim 24 wherein said another portion includes one or more wedges tending to direct snow into the snow channel.

27. A snow ski comprising:
a gliding surface disposed at a bottom of the ski;
a pair of keels defined within the gliding surface, said pair of keels extending downwardly and positioned away from outer edges of the ski, said pair of keels defining portions of a snow channel, with another portion of the ski directing snow into the snow channel; and
means for providing deep powder flotation to the ski, said means including a flexible wing structures extending ourwardly away from the pair of keels wings, said flexible structures being substantially more flexible than other portions of the ski and capable of substantial deformation during ski turning maneuvers.

28. The ski of claim 27 further comprising:
means for strengthening said means for providing flotation, said means for strengthening defined by a discrete elongated rib having a thicker width than said means for providing and being located proximate to an outer edge of the ski.
